(19) United States
(12) Patent Application Publication
(10) Pub. No.: US 2005/0242751 A1
(43) Pub. Date: Nov. 3, 2005

(54) Inverter circuit with a power factor corrector

(75) Inventors: Chien-Wen Chou, Hsin-Tien City (TW); Ying-Nan Cheng, Hsin Tien City (TW); Kuang-Ming Wu, Hsin-Tien City (TW); Chin-Biau Chung, Hsin-Tien City (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/115,178

(22) Filed: Apr. 27, 2005

Related U.S. Application Data
(63) Continuation-in-part of application No. 10/833,033, filed on Apr. 28, 2004.

(51) Int. Cl. H05B 37/00

(52) U.S. Cl. 315/247; 315/224; 315/291; 315/312

(57) ABSTRACT

The present invention provides an inverter circuit with a power factor corrector. A power source provides a power signal of alternating current. An electromagnetic interference filtering unit and a rectifier unit receive the power signal of alternating current, filter and rectify the power signals, and then output a full-wave/half-wave power signal of direct current. A voltage adjusting unit provides a voltage adjusting value. A first power factor corrector receives the full-wave/half-wave power signal of direct current, connected to the voltage adjusting unit, converting the voltage of the full-wave/half-wave power signal of direct current in accordance with the voltage adjusting value, and then outputting a power signal. An inverter steps up the voltage and outputting a power signal with high voltage to a load which is subsequently connected to the inverter, such that the power signal with high voltage has a preferred corrected power factor.

This is a continuation-in-part, and claims priority, of from U.S. patent application Ser. No. 10/833,033 filed on Apr. 28, 2004, entitled “Inverter circuit with a power factor corrector”.

### FIELD OF THE INVENTION

The present invention relates to an inverter circuit, and more particularly to an inverter circuit for generating a power signal with high voltage to drive a load.

### BACKGROUND OF THE INVENTION

Recently, electronic products and computers are popular, wherein a liquid crystal display is rather popular and widely applied to various electronic products. Particularly, the liquid crystal display is applied to the electronic products which are used in the house, and therefore a consumer increasingly requests the quality of the electronic products as the electronic products are popular. Accordingly, manufacturers and researchers pay more attention to the multi-function and power saving function applied in the electronic product, such that the electronic product has competitiveness on the market. In addition, people increasingly pay much attention to environmental consciousness, and therefore the harmonic current generated by the power consuming current of the electronic product and the computer is requested to improve.

According to current driving circuits, there are two conventional technologies as follows: a first driving circuit and a second driving circuit.

The first driving circuit includes a power source 10 which directly provides a power signal of alternating current to a power supply 28. After the voltage is transformed by the power supply 28, the power supply 28 outputs the power signal to an inverter 13 which steps up the voltage and outputs the power signal of high voltage, shown in FIG. 1. The conventional power supply 28 for processing the power signal of alternating current outputted by the power source 10 includes an electromagnetic interference filtering unit 11, a rectifier unit 12, a power factor corrector 15 and a converting unit 16 (DC to DC). The electromagnetic interference filtering unit 11 and the rectifier unit 12 receive the power signal of alternating current, filter and rectify the power signal, and then output a full-wave/half-wave power signal of direct current. The power factor corrector 15 receives the full-wave/half-wave power signal of direct current, corrects the power factor, and outputs the power signal to the converting unit 16. The converting unit 16 receives the power signal, converts the voltage, and outputs the power signal with low voltage to the inverter 13. Then, the inverter 13 steps up the voltage and outputs a power signal with high voltage to a load 14 which is subsequently connected to the inverter 13. The advantage of the first driving circuit is that the conventional power supply 28 is directly utilized to transform the voltage and there is no additional circuit to be requested. However, the inverter 13 needs to increase operating efficiency during increasing voltage, because of the restriction of the low voltage power signal outputted by the conventional power supply 28. Thus, this will increase the operating thermal energy of the inverter 13 and further affect the original power output thereof.

Referring to FIG. 2, it depicts the second driving circuit. Compared with the first driving circuit, the second driving circuit is characterized in that the electromagnetic interference filtering unit 11 and the rectifier unit 12 receive the power signal of alternating current outputted by the power source 10, filter and rectify the power signals, and then output a full-wave/half-wave power signal of direct current. The full-wave/half-wave power signal of direct current is a power signal with intermediate voltage (e.g. the voltage of the full-wave/half-wave power signal of direct current is 150V if the voltage of the power source 10 is 110V). The inverter 13 receives the power signal with intermediate voltage, steps up the voltage, and then outputs a power signal with high voltage to the load 14. The second driving circuit outputs the power signal with intermediate voltage to the inverter 13 and therefore the power loss of converting unit 16 (DC to DC) can be decreased so as to decrease the thermal energy thereof and increase the lifetime thereof. However, the second driving circuit outputs the power signal that still has the harmonic wave because of its lack of a power factor corrector, and therefore there can be a problem of harmonic distortion. Furthermore, because there is a problem that the phase of the voltage is different from that of the current, the power cannot be corrected so as to cause the power factor with lower value and further not meet the requirement of test standard of the electronic products which are used in the house in various countries.

In addition, the above-mentioned two driving circuits have a common disadvantage being that the above-mentioned two driving circuits only output the fixed voltage when the brightness of the liquid crystal display or liquid crystal TV must be adjusted in accordance with the interference of external light. Thus, the inverter 13 cannot be controlled to output different voltage for adjusting the brightness. If there is an additional control circuit to be connected, this will increase the design cost and the complexity of circuitry.

Accordingly, there is a need for an inverter circuit with a power factor corrector to solve the above-mentioned problems and disadvantages.

### SUMMARY OF THE INVENTION

It is an object of the present invention to provide a driving circuit which can correct the power factor and simultaneously output the adjustable power signal with intermediate voltage to an inverter, wherein the driving circuit provides different power standard of the outputted power signal with intermediate voltage and associates with different types of inverter standard in accordance with the voltage adjusting value of a voltage adjusting unit which is connected to a first power factor corrector, so as to have a preferred corrected power factor.

It is another object of the present invention to provide a second power factor corrector connecting with a power factor corrector of the present invention in parallel, wherein the fixing voltage type second power factor corrector outputs the power signal to a converting unit, and the converting unit receives the power signal, converts the voltage, and then outputs a power signal with low voltage to another auxiliary component (e.g. a driver IC) on a circuit board, such that the present invention further has a module type design.

It is a further object of the present invention to provide a converting unit being a branch of and connected to the first power factor corrector, and connecting with the inverter in parallel, wherein the converting unit receives the power signal, converts the voltage, and then outputs a power signal with low voltage.

In order to achieve the foregoing objects, the present invention provides an inverter circuit with a power factor corrector including:
a power source providing a power signal of alternating current;
an electromagnetic interference filtering unit and a rectifier unit receiving the power signal of alternating current, filtering and rectifying the power signals, and then outputting a full-wave/half-wave power signal of direct current;
a voltage adjusting unit providing a voltage adjusting value;
a first power factor corrector receiving the full-wave/half-wave power signal of direct current, connected to the voltage adjusting unit, converting the voltage of the full-wave/half-wave power signal of direct current in accordance with the voltage adjusting value, and then outputting a power signal; and
an inverter stepping up the voltage and outputting a power signal with high voltage to a load which is subsequently connected to the inverter.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a control circuit of a backlight module in the prior art.

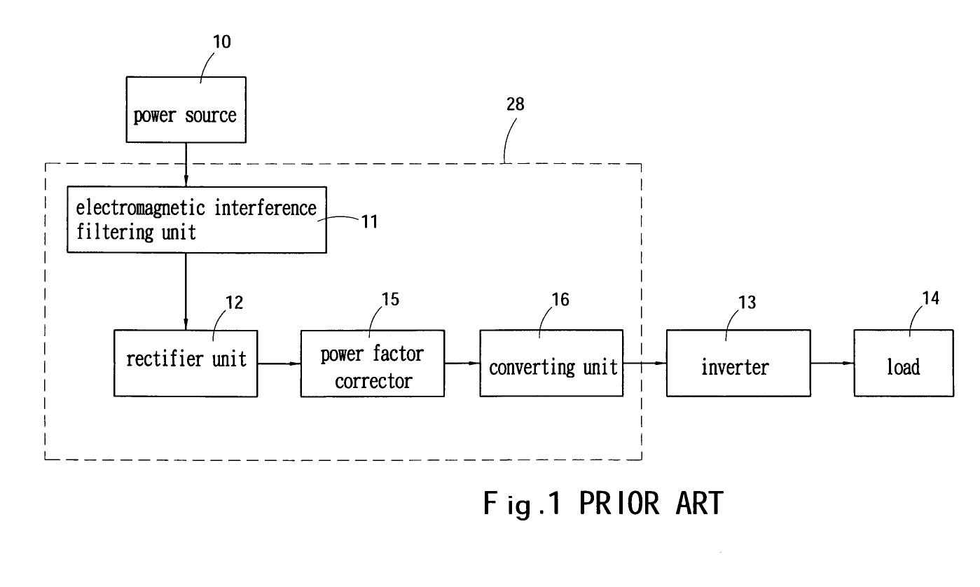

FIG. 2 is a block diagram of another control circuit of a backlight module in the prior art.

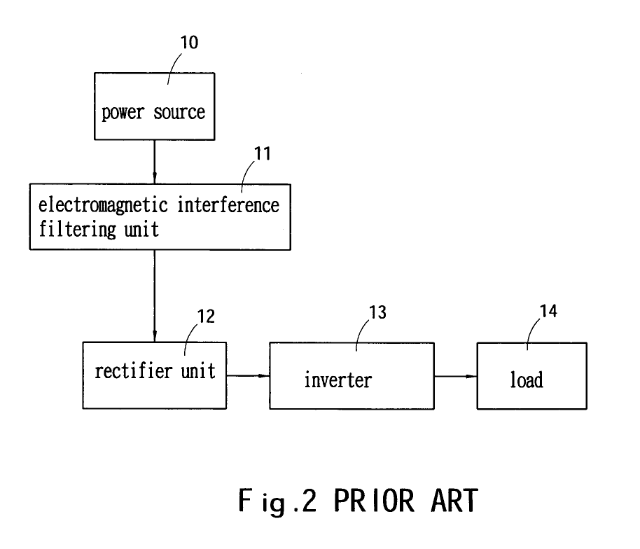

FIG. 3 is a block diagram of a circuit according to the first embodiment of the present invention.

FIG. 4 is a block diagram of a circuit according to the second embodiment of the present invention.

FIG. 5 is a block diagram of a circuit according to the third embodiment of the present invention.

### DESCRIPTION OF THE PREFERRED EMBODIMENTS

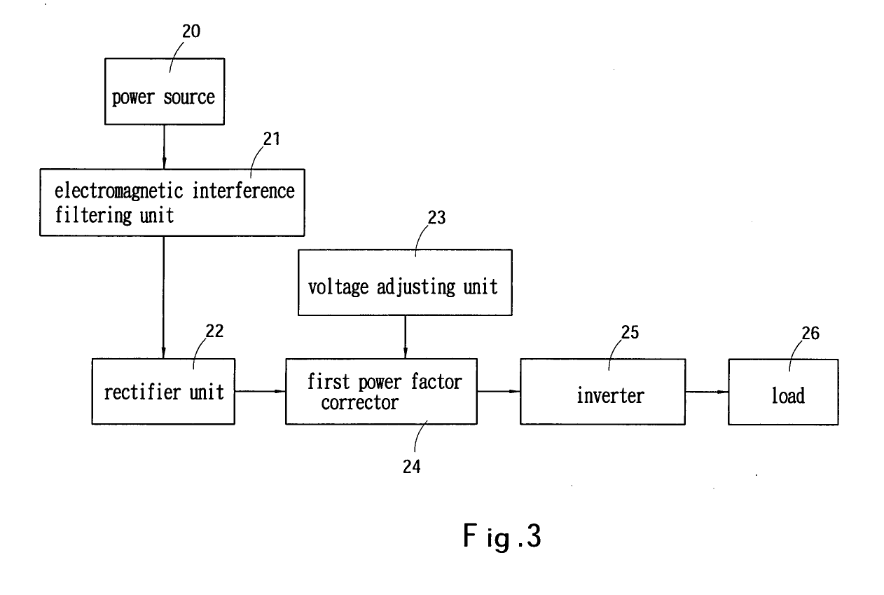

Referring to FIG. 3, it shows a block diagram of a circuit according to the first embodiment of the present invention. As shown in FIG. 3, the present invention discloses an inverter 25 circuit with the power factor correct function, and the inverter 25 outputs a power signal with high voltage to a load 26. The load 26 can be a cold cathode fluorescent lamp (CCFL). The driving circuit of the present invention further includes a power source 20, an electromagnetic interference filtering unit 21 and a rectifier unit 22.

The power source 20 provides a power signal of alternating current. The power source 20 is utility power. The power standard of the utility power is in accordance with the power standard of various countries (e.g. 110V or 220V).

The electromagnetic interference filtering unit (EMI) 21 and the rectifier unit 22 receive the power signal of alternating current, filter and rectify the power signals, and then output a full-wave/half-wave power signal of direct current. The necessity of the electromagnetic interference filtering unit (EMI) 21 depends on the standard of power supply in every country. The rectifier unit 22 is a diode bridge type rectifier.

The first power factor corrector 24 receives the full-wave/half-wave power signal of direct current. The first power factor corrector 24 is connected to a voltage adjusting unit 23 which can be a variable resistance (VR) or a fixed resistance. The voltage adjusting unit 23 provides a voltage adjusting value. The first power factor corrector 24 converts the voltage of the full-wave/half-wave power signal of direct current in accordance with the voltage adjusting value, and then outputs a power signal.

The inverter 25 steps up the voltage and outputs a power signal with high voltage to a load 26 which is subsequently connected to the inverter 25.

As shown in FIG. 3, the first power factor of the full-wave/half-wave power signal of direct current outputted by the rectifier unit 22 is corrected by the first power factor corrector 24, and therefore the harmonic distortion and phase deviation will be effectively improved. Furthermore, the voltage of the outputted power signal of the first power factor corrector 24 can be adjusted by setting the voltage adjusting value of the adjusting voltage unit 23. The voltage adjusting value set by the voltage unit 23 provides the different voltage standard in accordance with the first power factor corrector 24 being the step-up type, step-down type or step-up/down type. In this moment, the first power factor corrector 24 can output the different voltage standard, and therefore output the power signal with different voltage to the inverter 25, such that the inverter 25 receives the power signal with different voltage, outputs the power signal with different high voltage, and then controls the brightness of the load 26. Thus, an auxiliary component (e.g. a driver IC on a circuit board) acquires power supplied from the circuit of the present invention, and it is not necessary to dispose an additional power supplier such that the present invention has the module type design and further increases economic benefits.

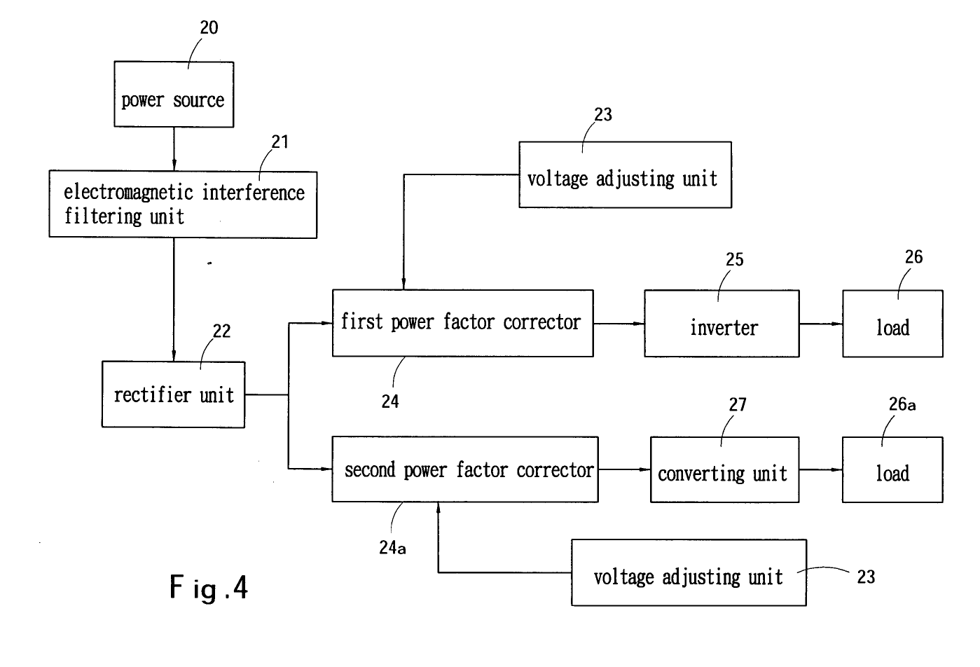

Referring to FIG. 4, it shows a block diagram of a circuit according to the second embodiment of the present invention. As shown in FIG. 4, the present invention can effectively correct the power factor of the power signal with high voltage outputted by the inverter 25 and control the brightness. Furthermore, a second power factor corrector 24a is a branch of and connected to the rectifier unit 22, and the second power factor corrector 24a and the first power factor corrector 24 are in parallel connection. Similarly, the second power factor corrector 24a can be connected to the voltage adjusting unit 23 which can be a variable resistance (VR) or a fixed resistance. The voltage adjusting value set by the voltage adjusting unit 23 provides the different voltage standard in accordance with the second power factor corrector 24a being the step-up type, step-down type or step-up/down type. The second power factor corrector 24a receives the full-wave/half-wave power signal of direct current and then outputs the processed power signal to a converting unit 27. The converting unit 27 receives the power signal, converts the voltage, and then outputs a power signal with low voltage to a load 26a which is subsequently connected to the converting unit 27.

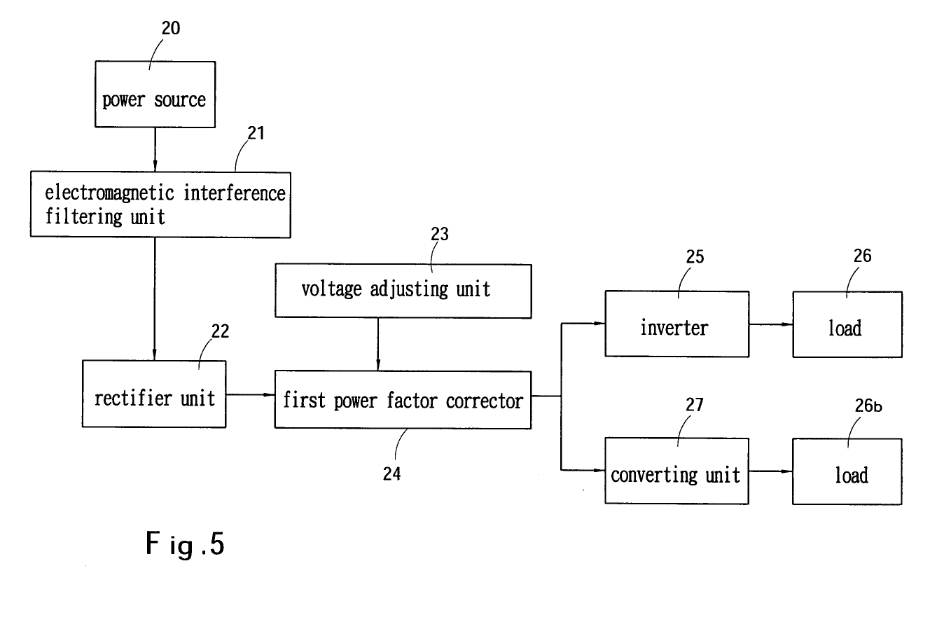

Referring to FIG. 5, it shows a block diagram of a circuit according to the third embodiment of the present invention. As shown in FIG. 5, the purpose of the circuit shown in FIG. 5 is the same as the purpose of the circuit shown in FIG. 4, and the circuit in the third embodiment provides a power signal with low voltage and outputs to a load 26b. In the third embodiment, the converting unit 27 is a branch of and connected to the first power factor corrector 24, and the converting unit 27 and the inverter 25 are in parallel connection. The converting unit 27 receives the power signal, converts the voltage, and then outputs a power signal with low voltage to the load 26b which is subsequently connected to the converting unit 27.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. An inverter circuit with a power factor corrector comprising:
a power source providing a power signal of alternating current;
an electromagnetic interference filtering unit and a rectifier unit receiving the power signal of alternating current, filtering and rectifying the power signals, and then outputting a full wave/half-wave power signal of direct current;
a voltage adjusting unit providing a voltage adjusting value;
a first power factor corrector receiving the full-wave/half-wave power signal of direct current, connected to the voltage adjusting unit, converting the voltage of the full-wave/half-wave power signal of direct current in accordance with the voltage adjusting value, and then outputting a power signal; and
an inverter stepping up the voltage and outputting a power signal with high voltage to a load which is subsequently connected to the inverter.

2. The inverter circuit with a power factor corrector according to claim 1, wherein the power source is utility power.

3. The inverter circuit with a power factor corrector according to claim 1, wherein the rectifier unit is a diode bridge type rectifier.

4. The inverter circuit with a power factor corrector according to claim 1, wherein the voltage adjusting unit is a variable resistance.

5. The inverter circuit with a power factor corrector according to claim 1, wherein the voltage adjusting unit is a fixed resistance.

6. The inverter circuit with a power factor corrector according to claim 1, wherein the load is a cold cathode fluorescent lamp.

7. The inverter circuit with a power factor corrector according to claim 1, further comprising:
a converting unit; and
a second power factor corrector being a branch of and connected to the rectifier unit, and connecting with the first power factor corrector in parallel, wherein the second power factor corrector outputs a power signal to the converting unit, and the converting unit receives the power signal, converts the voltage, and then outputs a power signal with low voltage to a load which is subsequently connected to the converting unit.

8. The inverter circuit with a power factor corrector according to claim 7, wherein the second power factor corrector is connected to another voltage adjusting unit which can be selected from a variable resistance (VR) and a fixed resistance.

9. The inverter circuit with a power factor corrector according to claim 1, further comprising:
a converting unit being a branch of and connected to the first power factor corrector, and connecting with the inverter in parallel, wherein the converting unit receives the power signal, converts the voltage, and then outputs a power signal with low voltage to a load which is subsequently connected to the converting unit.

10. An inverter circuit with a power factor corrector comprising:
a power source providing a power signal of alternating current; and
a rectifier unit receiving the power signal of alternating current, rectifying the power signals, and then outputting a full wave/half-wave power signal of direct current, wherein the rectifier unit is a branch of and connected to a first and second power factor correctors in parallel, the first power factor corrector converts the voltage of the full-wave/half-wave power signal of direct current and then outputs a power signal to an inverter, the inverter steps up the voltage and then outputs a power signal with high voltage to a load which is subsequently connected to the inverter, the second power factor corrector outputs a power signal to a converting unit, and the converting unit receives the power signal, converts the voltage, and then outputs a power signal with low voltage to a load which is subsequently connected to the converting unit.

11. The inverter circuit with a power factor corrector according to claim 10, wherein the power source is utility power.

12. The inverter circuit with a power factor corrector according to claim 10, wherein the rectifier unit is a diode bridge type rectifier.

13. The inverter circuit with a power factor corrector according to claim 10, wherein the rectifier unit is electrically connected to an electromagnetic interference filtering unit.

14. The inverter circuit with a power factor corrector according to claim 10, wherein the first power factor corrector is electrically connected to a voltage adjusting unit for providing a voltage adjusting value.

15. The inverter circuit with a power factor corrector according to claim 14, wherein the voltage adjusting unit is a variable resistance.

16. The inverter circuit with a power factor corrector according to claim 14, wherein the voltage adjusting unit is a fixed resistance.

17. The inverter circuit with a power factor corrector according to claim 10, wherein the second power factor corrector is electrically connected to another voltage adjusting unit for providing a voltage adjusting value.

18. The inverter circuit with a power factor corrector according to claim 17, wherein the voltage adjusting unit is a variable resistance.

19. The inverter circuit with a power factor corrector according to claim 17, wherein the voltage adjusting unit is a fixed resistance.

20. The inverter circuit with a power factor corrector according to claim 10, wherein the load is a cold cathode fluorescent lamp.
